(19) United States
(12) Patent Application Publication
(10) Pub. No.: US 2016/0122487 A1
(43) Pub. Date: May 5, 2016

(54) THERMOPLASTIC COMPOSITES

(71) Applicant: E I DU PONT DE NEMOURS AND COMPANY, Wilmington, DE (US)

(72) Inventors: Simona Percec, Philadelphia, PA (US); Stephen Neal Bair, Newark, DE (US); Ramabhadra Ratnagiri, Wilmington, DE (US); Martyn Douglas Wakeman, Gland (CH)

(21) Appl. No.: 14/814,551

(22) Filed: Jul. 31, 2015

Related U.S. Application Data
(60) Provisional application No. 62/075,418, filed on Nov. 5, 2014.

(51) Int. Cl. C08J 5/24; D06M 15/59

(52) U.S. Cl. CPC C08J 5/24; D06M 15/59; C08J 2377/06; C08J 2477/02; D06M 2101/40

(57) ABSTRACT

Provided are thermoplastic composites having improved flexural properties.

### CROSS REFERENCE TO RELATED APPLICATIONS

This application claims the benefit of U.S. Provisional Application No. 62/075418 , filed Nov. 5, 2014, now pending, the entire disclosure of which is incorporated herein by reference.

### BACKGROUND OF THE INVENTION

A thermoplastic composite (“TPC”) is a structure made from a fibrous material comprising long or continuous filaments impregnated with a polymer resin. Due to the combination of the fibrous material and resin, TPC's typically have mechanical characteristics that allow them to be used to make large structural and load-bearing parts traditionally made from metal, for example in automotive uses. The replacement of metal with a TPC often results in substantial weight reduction and design flexibility.

The fibrous material in a TPC is commonly glass or carbon fiber in a form in which there is a defined and continuous structure between individual fibers, such as in a mat, a needled mat and a felt, unidirectional fiber strands, bidirectional strands, multidirectional strands, multi-axial textiles, woven, knitted or braided textiles or combinations of these. The fibrous material is impregnated with resin in various ways, such as by layering polymer layers alternately with fibrous layers and subjecting the resulting stacked structure to heat and pressure to fully impregnate the fibrous material. The result is a hybrid between fibrous material and resin, in which the fibrous material is surrounded and impregnated by a matrix of polymer resin.

During the process to make TPC's, a rate determining step is the impregnation of the fibrous material with the matrix resin, which is done under pressure and heat. If the impregnation is incomplete, the TPC will have voids, resulting in inferior performance characteristics, and sometimes failure of the TPC under loads. The impregnation rate is sometimes increased by raising the pressure or increasing the temperature. These measures are far from ideal in that they require higher energy input, and often can result in oxidative decomposition of the matrix resin, which leads to TPC's having inferior performance characteristics. Longer impregnation times also reduce the cycle time to make a TPC, thus adding to cost. Maintaining a TPC under impregnation conditions for prolonged periods also results in oxidative decomposition of the matrix resin, even at lower temperatures and pressures. There is therefore an ongoing need to improve impregnation, and to reduce impregnation time.

U.S. Pat. No. 4,255,219 discloses a thermoplastic sheet material useful in forming composites. The disclosed thermoplastic sheet material is made of polyamide 6 and a dibasic carboxylic acid or anhydride or esters thereof and at least one reinforcing mat of long glass fibers encased within said layer.

US 2012/0108127 discloses thermoplastic composite materials wherein the matrix polyamide resin composition and the surface resin composition are selected from polyamide compositions comprising a blend of semi-aromatic polyamides.

U.S. Pat. No. 5,280,060 discloses polyamide resin compositions comprising a polyamide and at least one fluidity modifier selected from a carboxylic acid containing at least two carboxyl groups or a derivative thereof, an amine containing at least two nitrogen atoms, urea and urea derivatives.

### SUMMARY OF THE INVENTION

In a first aspect, the invention provides a thermoplastic composite comprising a fibrous material selected from the group consisting of non-woven structures, textiles, fibrous battings and combinations thereof, said fibrous material being impregnated with a matrix resin composition, wherein the matrix resin composition is selected from polyamide compositions comprising an aliphatic polyamide, a semi-aromatic polyamide, and blends of the foregoing, and from 0.1 to 3.0 wt % of one or more diamines, based on the matrix resin composition.

In a second aspect, the invention provides a process for making a thermoplastic composite, comprising the step of impregnating a fibrous material selected from the group consisting of non-woven structures, textiles, fibrous battings and combinations thereof, with a matrix resin composition comprising an aliphatic polyamide, a semi-aromatic polyamide, and blends of the foregoing, and from 0.1 to 3.0 wt % of one or more diamines, based on the matrix resin composition.

Abbreviations CF: carbon fiber HMD: 1,6-hexamethylene diamines DAN: 1,9-diaminononane DAO: 1,8-diaminooctane

HTN: semi-aromatic polyamide, which is made from diacids and diamines, and their derivatives, wherein at least part of the diacid content is aromatic. HTN may also be made from lactams, with added aromatic diacids. PBAB: poly(1,4-butanediol)bis(4-aminobenzoate) TPC: thermoplastic composite

### DETAILED DESCRIPTION OF THE INVENTION

The inventors have found that when a thermoplastic composite is made with a polyamide matrix resin, the addition of a diamine to the matrix resin results in a TPC having decreased void content, and improved flexural characteristics.

The fibrous material in the TPC is selected from the group consisting of non-woven structures, textiles, fibrous battings and combinations thereof. More particularly, it is selected from (a) non-woven structures that have random fiber orientation with chopped or continuous fiber in the form of a mat, a needled mat or a felt; (b) non-woven structures that have aligned fiber orientation, in the form of unidirectional fiber strands; (c) multi-axial textiles; and combinations thereof.

The fibrous material may be made up of glass or carbon fibers, or mixtures of these. Carbon fibers give a particularly good result.

Particularly preferred are bundles of uni-directional carbon fiber filaments, referred to as tow. Such bundles are usually available in bundles of 12,000 (“12 K”), 15,000 (“15 K”), 24,000 (“24 K”) and 30,000 (“30 K”). When woven tow is used, the number of filaments per bundle is preferably 35 k or less, as impregnation can be difficult above this. More preferably it is 25 K or less, for example, 24 K or 12 K.

The average length of the carbon fiber for use in a TPC is typically longer than 5 mm, more preferably longer than 10 mm, particularly preferably longer than 90 mm or 150 mm. In continuous fiber applications the fiber length is essentially infinite, running essentially the full length and/or width of the TPC article.

The carbon fiber is preferably sized. Preferred sizing agents are thermoplastic polyurethane, polyamides, and epoxy-functionalized sizing.

The matrix resin may comprise or consist of any polyamide or blend of polyamides, for example, aliphatic polyamides or semi-aromatic polyamides, or blends of these. In preferred embodiments, the polymer content of the matrix resin composition is essentially 100% polyamide.

Preferred aliphatic polyamides are poly(ε-caprolactam) (PA 6), poly(hexamethylene hexanediamide) (PA 66), poly(1,3-trimethylene hexanediamide) (PA3,6), poly(tetramethylene hexanediamide (PA46), poly(pentamethylene hexanediamide (PA56), hexamethylene dodecanediamide (PA612), poly(pentamethylene decanediamide) (PA510), poly(pentamethylene dodecanediamide) (PA512), poly(hexamethylene decanediamide) (PA610), poly(ε-caprolactam/hexamethylene hexanediamide) (PA6/66), poly(ε-caprolactam/hexamethylene decanediamide) (PA6/610), poly(ε-caprolactam/hexamethylene dodecanediamide) (PA6/612), poly(hexamethylene tridecanediamide) (PA613), poly(hexamethylene pentadecanediamide) (PA615), poly(ε-caprolactam/hexamethylene hexanediamide/hexamethylene decanediamide) (PA6/66/610), poly(ε-caprolactam/hexamethylene hexanediamide/hexamethylene dodecanediamide) (PA6/66/612), poly(ε-caprolactam/hexamethylene hexanediamide/hexamethylene decanediamide/hexamethylene dodecanediamide) (PA6/66/610/612), poly(2-methylpentamethylene hexanediamide/hexamethylene hexanediamide/) (PA D6/66), poly(decamethylene decanediamide) (PA1010), poly(decamethylene dodecanediamide) (PA1012), poly(11-aminoundecanamide) (PA11), poly(12-aminododecanamide) (PA12), PA6,12, PA12,12 and their copolymers and combinations. Particularly good flexural performance is obtained using PA6, PA66, or blends of these, in particular a blend of 75/25 PA66/PA6.

Preferred semi-aromatic polyamides are selected from the group consisting of polyamides made by polymerizing an aromatic acid, such as iso-phthalic acid and terephthalic acid, or mixtures of these, a C₃-C₁₂ aliphatic diamine, or mixtures of these, and a C₃-C₁₂ aliphatic diacid, or mixtures of these. Preferably the aromatic acid content is greater than 10 mole %, more preferably greater than 20 mole %, particularly preferably greater than 50 mole % based on the diacid content of the semi-aromatic polyamide. Preferred are semi-crystalline semi-aromatic polyamides, although amorphous semi-aromatic polyamides may also be used, alone or in blend with semi-crystalline polyamides. If iso-phthalic acid is present, it preferably constitutes not more than 80 mole % of the aromatic diacid content of the polyamide. Particularly good flexural performance is obtained for TPC's made with:

(1) a polyamide synthesized from the moieties hexamethylene diamine (HMD), 2-methyl pentamethylene diamine (2-MPMD) and terephthalic acid;

(2) a polyamide synthesized from the moieties hexamethylene diamine (HMD), terephthalic acid and adipic acid;

(3) a polyamide synthesized from the moieties hexamethylene diamine (HMD), isophthalic acid and terephthalic acid, and blends of all of the foregoing polyamides.

In particular a 40/40/20 blend of (1)/(2)/(3).

Additional suitable semi-aromatic polyamides are selected from:

(4) a semi-aromatic polyamide synthesized from the moieties hexamethylene diamine (HMD), 2-methyl pentamethylene diamine (2-MPMD) and terephthalic acid (or reactive derivatives of the foregoing), wherein the ratio between HMD and 2-MPMD is 50 mole %/mole 50 mole, based on the diamine content.

(5) a semi-aromatic polyamide synthesized from the moieties hexamethylene diamine (HMD), terephthalic acid and adipic acid (or reactive derivatives of the foregoing), wherein the ratio between terephthalic acid and adipic acid is 55 mole %/45 mole %, based on the diacid content.

(6) a semi-aromatic polyamide synthesized from the moieties hexamethylene diamine (HMD), isophthalic acid and terephthalic acid (or reactive derivatives of the foregoing), wherein the ratio between isophthalic acid and terephthalic acid is 70 mole % isophthalic/30 mole % terephthalic acid, based on the diacid content.

In particular a 40/40/20 blend of (4)/(5)/(6).

The diamine that is added to the matrix resin composition may be an aromatic diamine or an aliphatic diamine. Preferred diamines are selected from C₃-C₁₂ aliphatic diamines, for example tetramethylene diamine, hexamethylene diamine, octamethylene diamine, nonamethylene diamine, decamethylene diamine, 2-methylpentamethylene diamine, 2-ethyltetramethylene diamine, 2-methyloctamethylene diamine, trimethylhexamethylene diamine, and combinations thereof. Also preferred are diamines selected from the group consisting of diamines of the Formula 1:

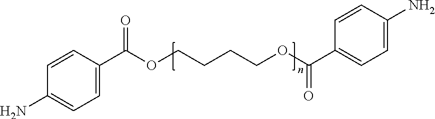

where n is an integer chosen from 1-10.

The diamine may also be in the form of a carbamate derivative, for example, (6-aminohexyl)carbamic acid. Diamine carbamates decarboxylate when exposed to heat to yield the corresponding diamine.

Particularly preferred diamines are selected from hexamethylene diamine (HMD), 1,9-diaminononane (DAN), 1,8-diaminooctane (DAO), poly(1,4-butanediol)bis(4-aminobenzoate) (PBAB), and mixtures of these.

Preferably the diamine is present at from 0.1 to 3.0 wt %, more preferably from 0.5 to 1.5 wt %, based on the matrix resin composition. For example, 0.5, 0.75, 1.0 and 1.5 wt % give good results.

In another preferred embodiment, the matrix resin composition additionally comprises a heat-stabilizer. Particularly preferred is a blend of copper iodide, potassium iodide and aluminum stearate (“Triblend”). Preferably 10 to 50 weight percent copper halide, 50 to 90 weight percent potassium iodide, and from zero to 15 weight percent aluminum stearate. More particularly preferred is the following ratio: Cul/KI/Al=7/1/0.5

The inventors have found that when the heat stabilizer is added to the matrix resin composition, void content is further reduced, and flexural properties are further improved. The heat stabilizer (in particular Triblend) is preferably used at 0.25 to 1.5 wt %, more preferably 0.5 to 1.0 wt % based on the matrix resin composition, for example 0.75 wt %. The heat stabilizer is particularly effective when the matrix resin composition is an aliphatic polyamide or a blend of aliphatic polyamides, for example PA6, PA66, or blends of these, in particular a blend of 75/25 PA66/PA6.

Triblend alone, i.e. in the absence of added diamine, also reduces void content and improves flexural properties of the resulting TPC, in particular at 0.25 to 1.5 wt % Triblend in PA66/PA6, more particularly PA66/PA 75/25. Preferably the Triblend has a ratio Cul/KI/Al of 7/1/0.5.

The addition of Triblend and diamine gives a reduction in void content that is greater than the sum of the reduction with diamine alone and with Triblend alone. Particularly preferred concentrations of the two components in a matrix resin that is selected from aliphatic polyamides and blends thereof, are as follows: 0.25 to 1.5 wt % Triblend, more preferably 0.5 to 1.0 wt % Triblend plus 0.1 to 3.0 wt %, more preferably from 0.5 to 1.0 wt % diamine, based on the matrix resin composition. For example 0.75 wt % Triblend plus 0.5, 0.75, 1.0 and 1.5 wt % diamine give good results. Preferably the Triblend has a ratio Cul/KI/Al of 7/1/0.5.

The matrix resin composition may additionally comprise one or more additives selected from the group consisting of heat stabilizers, oxidative stabilizers, fillers and reinforcing agents, flame retardants and combinations thereof.

Particularly preferred TPC's can be prepared using PA66/PA66, preferably at 75/25 with 0.75 to 1.25 wt % diamine, preferably HMD or DAN, and carbon fiber, preferably 12K tow carbon fiber.

Particularly preferred TPC's can be prepared using semi-aromatic polyamides selected from

(1) a polyamide synthesized from the moieties hexamethylene diamine (HMD), 2-methyl pentamethylene diamine (2-MPMD) and terephthalic acid;

(2) a polyamide synthesized from the moieties hexamethylene diamine (HMD), terephthalic acid and adipic acid;

(3) a polyamide synthesized from the moieties hexamethylene diamine (HMD), isophthalic acid and terephthalic acid, and blends of all of the foregoing polyamides. with 0.75 to 1.65 wt % diamine, preferably HMD, DAN, PBAB or DAO, and carbon fiber, preferably 12K tow carbon fiber.

The matrix resin composition may be prepared before making the TPC using any method for compounding polyamides with additives. For example, the polyamide resin may be blended as a finely divided solid (granules or powder) with the diamine. If heat stabilizer is added it may also be added to the finely divided solid. Alternatively, the polyamide resin may be melt blended with the diamine and/or heat stabilizer in an extruder.

The invention also provides a process for making a thermoplastic composite, comprising the step of impregnating a fibrous material selected from the group consisting of non-woven structures, textiles, fibrous battings and combinations thereof, with a matrix resin composition comprising an aliphatic polyamide, a semi-aromatic polyamide, and blends of the foregoing, and from 0.1 to 3.0 wt % of one or more diamines, based on the matrix resin composition.

The TPC's of the invention may be made using known methods. A TPC is a structure in which the fibrous material, in particular carbon fiber material, is impregnated with the matrix polyamide composition to form a consolidated unit.

In one method, the fibrous material may be stacked alternately with polyamide films, and the stacked structure is then subjected to pressure and heat, causing the polyamide to melt and impregnate the fibrous material, consolidating to produce a TPC/laminate. Alternatively, if the fibrous material is in the form of unidirectional bundles of fibers (referred to as tow), it can be fed through a die, and have molten polyamide coextruded under pressure so as to impregnate the fibers. This kind of TPC is often referred to as unidirectional tape, because it is typically manufactured as narrow bands that are rolled up like tape, with the fibers running essentially infinitely in the longitudinal axis of the tape. Unidirectional tape can also be prepared by a pressing method, as described above. It is also known to stack multiple layers of unidirectional fibers with the fibers running in different directions, for example perpendicular to each other, or at any angle.

In another method, the fibrous material is layered with the matrix resin composition in finely divided solid form (i.e. granules or powder), and the resulting structure is then subjected to pressure and heat, causing the polyamide to melt and impregnate the fibrous material, consolidating to produce a TPC/laminate.

The TPC's of the invention have decreased void content as compared to TPC's made with matrix resin not including a diamine at 0.1 to 3.0 wt %, based on the matrix resin composition. Decreased void content signifies a TPC of superior quality.

Void content in TPC/laminates can be calculated based upon the difference in theoretical density (ρ_{theory}) and experimentally measured density (ρₘₑₐₛᵤᵣₑ), following Equation 1. Theoretical density is determined following Equation 2, where ρ_{fiber} is the density of the fiber, and ρᵣₑₛᵢₙ is the density of the resin, while measured density is the quotient of the mass and volume of a TPC/laminate.

$$\begin{matrix}\% Voids = 100 \times ( \frac{{ρ}_{theory} - {ρ}_{measure}}{{ρ}_{theory}} ) . & Equation 1 \\ {ρ}_{theory} = vol {fraction}_{fiber} \times {ρ}_{fiber} + vol {fraction}_{resin} \times {ρ}_{resin} . & Equation 2\end{matrix}$$

The TPC's of the invention show a reduction of void content as compared to TPC's prepared with the same matrix resin, minus the added diamine, and prepared under the same conditions. In general, the reduction of void content is greater than 10%, preferably greater than 20%, more preferably greater than 30%, as compared to a TPC prepared under the same conditions with the same matrix resin without added diamine.

The TPC's of the invention, in particular those in which the matrix resin is selected from aliphatic polyamides and blends thereof, show a reduction in void content when a blend of copper iodide, potassium iodide and aluminum stearate (“Triblend”), is added to the matrix resin, more particularly preferred 10 to 50 weight percent copper halide, 50 to 90 weight percent potassium iodide, and from zero to 15 weight percent aluminium stearate, particularly preferably in the following ratio: Cul/KI/Al=7/1/0.5, as compared to a TPC prepared under the same conditions with the same matrix resin without added Triblend. When Triblend is added without diamine, the reduction in void content is greater than 10%, as compared to a TPC prepared under the same conditions with the same matrix resin without added Triblend. When Triblend and diamine are added to the matrix resin composition, the reduction in void content is greater than 20%, more preferably greater than 30%, as compared to a TPC prepared under the same conditions with the same matrix resin without added Triblend and diamine. The inventors have found that the addition of Triblend plus diamine gives a reduction in void content that is greater than the sum of reductions achieved with added diamine and added Triblend. Flexural mechanical analysis was performed following ASTM protocol D790-10 “Standard test methods for flexural properties of unreinforced and reinforced plastics and electrical insulating materials”. For this 3-poing bending test, a span-to-depth ratio of 16:1 is used, where depth refers to the laminate thickness. Laminate strips were 6 cm long×2 cm wide, with thicknesses of about 0.15 cm. Flexural modulus and flexural strength were measured.

The TPC's of the invention show improved flexural strength and improved flexural modulus as compared to TPC's prepared under the same conditions with the same matrix resin without added diamine.

In general, the improvement in flexural modulus is greater than 10%, preferably greater than 20%, more preferably greater than 30% or particularly preferably greater than 40%, as compared to a TPC prepared under the same conditions with the same matrix resin without added diamine.

In general, the improvement in flexural strength is greater than 25%, preferably greater than 30%, more preferably greater than 40%, as compared to a TPC prepared under the same conditions with the same matrix resin without added diamine.

The TPC's of the invention may be overmolded to make articles. In overmolding, the TPC is softened by heating, stamped or shaped to fit inside an injection mold, placed in the mold, and an overmolding resin is injected onto part or all of the surface of the TPC. The overmolding resin adheres to the surface of the TPC. The TPC can be entirely encapsulated, or features may be added to its surface, such as support stays, functional/design features, etc.

Due to their excellent mechanical characteristics, the TPC's of the invention are particularly suited to make large structural and/or load-bearing parts. For example: components for automobiles, trucks, commercial airplanes, aerospace, rail, household appliances, computer hardware, hand held devices, recreation and sports, structural components for machines, structural components for buildings, structural components for photovoltaic equipment or structural components for mechanical devices.

Examples of automotive applications include, without limitation, seating components and seating frames, engine cover brackets, engine cradles, suspension arms and cradles, spare tire wells, chassis reinforcement, floor pans, front-end modules, steering column frames, instrument panels, door systems, body panels (such as horizontal body panels and door panels), tailgates, hardtop frame structures, convertible top frame structures, roofing structures, engine covers, housings for transmission and power delivery components, oil pans, airbag housing canisters, automotive interior impact structures, engine support brackets, cross car beams, bumper beams, pedestrian safety beams, firewalls, rear parcel shelves, cross vehicle bulkheads, pressure vessels such as refrigerant bottles and fire extinguishers and truck compressed air brake system vessels, hybrid internal combustion/electric or electric vehicle battery trays, automotive suspension wishbone and control arms, suspension stabilizer links, leaf springs, vehicle wheels, recreational vehicle and motorcycle swing arms, fenders, roofing frames and tank flaps.

Examples of household appliances include without limitation washers, dryers, refrigerators, air conditioning and heating. Examples of recreation and sports include without limitation inline-skate components, baseball bats, hockey sticks, ski and snowboard bindings, rucksack backs and frames, and bicycle frames. Examples of structural components for machines include electrical/electronic parts such as for example housings for hand held electronic devices, and computers.

The invention is illustrated with the following non-limiting examples.

### EXAMPLES

Materials

Triblend1 is a mixture of copper iodide, potassium iodide and aluminum stearate in the following ratio: Cul/KI/Al=7/1/0.5

Carbon fiber: the number of individual fibers per carbon tow used for fabric formation including weaving is defined by the designation below where, for example, 12,000 filaments per bundle is indicated by 12k. Thermoplastic (TPU)-sized 12k CF grade 34-700WD 12k was received from Grafil, Inc. (Sacramento, CA) and woven into a fabric of areal density of 370 g/m² featuring a 2×2 twill weave.

PPA1 is a semi-aromatic polyamide synthesized from the moieties hexamethylene diamine (HMD), 2-methyl pentamethylene diamine (2-MPMD) and terephthalic acid (or reactive derivatives of the foregoing). The ratio between HMD and 2-MPMD is 50 mole/0/50 mole %, based on the diamine content.

PPA2 is a semi-aromatic polyamide synthesized from the moieties hexamethylene diamine (HMD), terephthalic acid and adipic acid (or reactive derivatives of the foregoing). The ratio between terephthalic acid and adipic acid is 55 mole/0/45 mole %, based on the diacid content.

PPA3 is a semi-aromatic polyamide synthesized from the moieties hexamethylene diamine (HMD), isophthalic acid and terephthalic acid (or reactive derivatives of the foregoing). The ratio between isophthalic acid and terephthalic acid is 70 mole % isophthalic/30 mole % terephthalic acid, based on the diacid content.

Preparation of Physical Blends of Polyamides and Diamines and/or Other Additives

The polyamide resins were used from commercial sources or from extrusion blending in the form obtained or ground into granules using a Wiley Mill. Resins were dried for ˜18 h at 90° C., under vacuum with slight nitrogen purge. The diamine additives were dried for about ˜18 h under high vacuum. If chunky, the additives were ground with mortar/pestle to a powder and then dried ˜18 h under high vacuum. Heat stabilizers if used were dried under high vacuum prior use.

Physical blends of polyamide resins and additives were prepared according to the following procedure. Typically 15 grams of dried polyamide resin or mixture of resins in form of powder, granules (˜1 mm), medium pellets (˜1 mm×3 mm), or pellets (˜3 mm×3 mm), was weighed into a 2 oz. jar. Additive was weighed into the glass jar. The jar was capped and then hand shaken for 1-2 min. Additives were typically used at 0.5%, 1.0%, and 1.5% concentration (by weight). For example for a 1% additive concentration, 15 grams of polyamide resin (or blend resins) was used with 0.15 grams of additive.

Preparation of Melt Blends of Polyamides and Diamines and/or Other Additives

Melt blends of polyamides with diamines and other additives were prepared using a Prism 16 mm twin-screw extruder manufactured by Welding Engineers, Inc. USA. The general procedure of melt blending was as follows: The required amounts of the dried components were weighed and mixed into a batch. The mixture was fed into a twin-screw extruder fitted with a 0.125″ die and three temperature zones maintained at 280-300° C. Screw design was chosen to have separate melting and mixing zones and pellets of the blend were extruded typically at 75 rotations per minute (rpm). Resulting blends were dried for 8 h at 100° C. under vacuum, prior to any testing.

Preparation of Composites Using Polyamide Resins or Their Blends With or Without Additives With Grafil Carbon Fiber 12k

For each composite made, three ˜5.5∝×5.5″ pieces of 12 K thermoplastic polyurethane (TPU)-sized carbon fabric were cut. Each composite was prepared using three layers of fabric and four layers of resin (˜3.2 g resin per layer). Two 5″×5″ (outside diameter) (4″×4″ interior diameter) Kevlar® paper frames were prepared.

Two stainless steel plates 6.5″×6″ (top plate) and 6.5″×8″ (bottom plate) were used to lay out each composite.

One Kevlar frame was taped to the bottom stainless steel plate. Using a balance, 3.2 g resin mixture was added to the inside of frame and distributed with a spatula to cover most of the interior of the frame (the jar of blended resin was shaken before each layer was applied). One piece of 12K carbon fabric was placed on top of the resin. Another layer of resin was added to the top of the fabric. This layering process was repeated until the desired number of layers was achieved.

The top stainless steel plate was placed over the layered structure, and using a preheated Carver press (typically 340° C. for aliphatic polyamide resins) a composite was fabricated over a total 2 minute period time at 25 bar (5,800 psi). Depending on resin form, melt time varied between ˜10-15 sec. (powder), ˜20-30 sec. (medium pellets), and ·30-40 sec. (larger pellets) before desired pressure was applied. The resulting composite was then removed from the press and a placed in a second room press at room temperature and 25 bar (5,800 psi) for 5 min to cool under pressure.

Evaluation of Laminates for Void Volume Content

CF composites made with different resin compositions were evaluated for volume void content according to the method described as follows:

1. A square sample of each composite was cut with tin snips. An average composite thickness was calculated from at least ten measurements (at the center, ˜2 cm from the edge) measured with an outside micrometer caliper (0.025 inch per turn, graduated in 0.001 increments). Composite sample area was calculated from length and width measurements with a 15 cm rule. From area and thickness measurements, composite sample volume was calculated.

2. Composite sample weight was recorded on a 3 decimal place balance. From weight and calculated volume (normally this is done by immersion in water), composite density (by ruler) was calculated. For all composites, a value of 30 wt % resin was assumed. From this value, composite density (by assumed carbon fiber/resin proportion) was calculated; the density of sized Grafil carbon fiber fabric is 1.8 g cm⁻³ and the density of the resin was taken as 1.14 g cm⁻³. Composite density (by assumed carbon fiber/resin proportion) is the composite density of a theoretically non-voided composite and, thus, should be (and is) greater than composite density (by ruler). From these two densities, composite percentage void content was calculated.

$$\begin{matrix}\% Voids = 100 \times ( \frac{{ρ}_{theory} - {ρ}_{measure}}{{ρ}_{theory}} ) . & Equation 1 \\ {ρ}_{theory} = vol {fraction}_{fiber} \times {ρ}_{fiber} + vol {fraction}_{resin} \times {ρ}_{resin} . & Equation 2\end{matrix}$$

Volume Void Content of PA 6,6/PA 6 Blend Laminates

Laminates were made with 12K CF using as a matrix the resin compositions shown in Table 1 in the form of pellets or films. These laminates were made following the procedure described above. The laminates were measured for void volume content according to the procedure described above. All laminates were 3-layer 12K with extruded blend pellets or their films and were processed at 340° C. for 2 min. The results are shown in Table 1. Examples of the invention are designated with an “E”, whereas comparative examples are designated with a “C”.

TABLE 1
Void volume (%) for laminates made with various polyamide
blends

| | | | | |
|---|---|---|---|---|
| | | Heat stabilizer | | |
| Example | | (Triblend1) | | Voids |
| No. | Polyamide | (wt %) | Diamine | (%) |

Laminates made with resin pellets

| | | | | |
|---|---|---|---|---|
| C1 | PA66/PA6 75/25 | 0 | 0 | 7.7 |
| C2 | PA66/PA6 75/25 | 0.75 | 0 | 6.8 |
| E1 | PA66/PA6 75/25 | 0 | 1 wt % HMD | 6.1 |
| E2 | PA66/PA6 75/25 | 0 | 1 wt % DAN | 5.2 |
| E3 | PA66/PA6 75/25 | 0.75 | 1 wt % HMD | 4.2 |
| E4 | PA66/PA6 75/25 | 0.75 | 1 wt % DAN | 4.8 |

Laminates made with films

| | | | | |
|---|---|---|---|---|
| C3 | PA66/PA6 75/25 | 0.75 | 0 | 6.9 |
| E5 | PA66/PA6 75/25 | 0.75 | 1 wt % HMD | 1.5 |
| E6 | PA66/PA6 75/25 | 0.75 | 1 wt % DAN | 1.7 |

From Table 1 it is clear that the volume void content of laminates made with aliphatic polyamides with added diamine with or without Triblend are lower than control.

Mechanical properties of CF laminates with PA 6,6/PA 6 blends Flexural mechanical analysis was performed following ASTM protocol D790-10 “Standard test methods for flexural properties of unreinforced and reinforced plastics and electrical insulating materials”. For this 3-poing bending test, a span-to-depth ratio of 16:1 was used, where depth refers to the laminate thickness. Samples were dried at 90° C. for 16 hrs, and tested quickly at 20° C. in the dried state without allowing moisture absorption. Laminate strips were 6 cm long×2 cm wide, with thicknesses of about 0.15 cm. These were cut to appropriate dimensions for flexural mechanical analysis using a MK-377 Tile Saw from MK Diamond Products, Inc. (Torrance, Calif.).

The results are shown in Table 2. Examples of the invention are designated with an “E”, whereas comparative examples are designated with a “C”.

It can be seen that the laminates made of pellets of 75/25 PA 6,6/PA 6 blends with 1% HMD or DAN have better flexural properties than the control. The same blends with 1% HMD or DAN and 0.75% Triblend also have better flexural properties than the control. The laminates made with films of blends of 75/25 PA 6,6/PA 6 with 1% HMD or DAN and 0.75% Triblend have about 2.3 times increase in flex strength and 2.7 times increase in flex modulus compared with control samples prepared under similar conditions.

TABLE 2
Flex Modulus (GPa) and Flex strength (MPa) for
laminates made with various polyamide blends

| | | | | | |
|---|---|---|---|---|---|
| | | Heat stabilizer | | | |
| Example | | (Triblend1) | | Flex modulus | Flex strength |
| No. | Polyamide | (wt %) | Diamine | (GPa) | (MPa) |

Laminates made with resin pellets

| | | | | | |
|---|---|---|---|---|---|
| C1 | PA66/PA6 75/25 | 0 | 0 | 27.5 | 459.4 |
| C2 | PA66/PA6 75/25 | 0.75 | 0 | 26.1 | 423.7 |
| E1 | PA66/PA6 75/25 | 0 | 1 wt % HMD | 36.9 | 637.6 |
| E2 | PA66/PA6 75/25 | 0 | 1 wt % DAN | 35.1 | 593.3 |
| E3 | PA66/PA6 75/25 | 0.75 | 1 wt % HMD | 39.5 | 671.5 |
| E4 | PA66/PA6 75/25 | 0.75 | 1 wt % DAN | 38.9 | 607.8 |

Laminates made with films

| | | | | | |
|---|---|---|---|---|---|
| C3 | PA66/PA6 75/25 | 0.75 | 0 | 15.2 | 281.2 |
| E5 | PA66/PA6 75/25 | 0.75 | 1 wt % HMD | 46.8 | 689.2 |
| E6 | PA66/PA6 75/25 | 0.75 | 1 wt % DAN | 39.8 | 635.5 |

Laminates Made With HTN's and Diamine Additives and Grafil Carbon Fiber 12K

Laminates were made with high temperature nylons (HTN), namely PPA1 and PPA2, and a blend of PPA1/PPA2/PPA3 (40/40/20) using 12K carbon fiber tow. HMD was added to the resins in different concentrations. The resulting laminates were evaluated for flexural properties and the results are shown in Table 3 below.

TABLE 3
Void content, flex modulus (GPa) and flex strength (MPa) for
laminates made with various semi-aromatic polyamide blends

| | | | | | |
|---|---|---|---|---|---|
| Example | | Diamines (other | | Flex modulus | Flex strength |
| No. | Polyamide | additives) | Voids (%) | (GPa) | (MPa) |

Laminates made with PPA1

| | | | | | |
|---|---|---|---|---|---|
| C4 | PPA1 | 0 | 3.9 | 35 | 550 |
| E7 | PPA1 | 1.0 wt % HMD | 2.14 | 44.4 | 747.9 |
| E8 | PPA1 | 1.5 wt % HMD | 0.7 | 56.8 | 800.0 |
| E9 | PPA1 | 1.5 wt % DAO | 1.6 | 50 | 1001 |

Laminates made with PPA2

| | | | | | |
|---|---|---|---|---|---|
| C5 | PPA2 | 0 | 5.6 | 30 | 480 |
| E10 | PPA2 | 1.0 wt % HMD | 2.5 | 51.2 | 945.1 |

Laminates made with a blend of PPA1/PPA2/PPA3 40/40/20

| | | | | | |
|---|---|---|---|---|---|
| C6 | PPA1/PPA2/PPA3 | 0 | 7.9 | 29 | 514 |
| | 40/40/20 (pellets) | | | | |
| E11 | PPA1/PPA2/PPA3 | 1.0 wt % HMD | 5.2 | 35 | 739 |
| | 40/40/20 (pellets) | | | | |
| E12 | PPA1/PPA2/PPA3 | 1.0 wt % PBAB | 2.3 | 46.7 | 679 |
| | 40/40/20 (film) | (0.4 wt % | | | |
| | | Irganox 1098) | | | |

The PPA1 shown in Table 3 was in the form of powder and PPA2 was in the form of granules (pellets which were ground using a Wiley Mill and Liquid N₂). The laminates were obtained at 390° C. and 25 bar pressure with a lamination time of 1.5 min except for laminates made with PPA2 which were held at pressure for 2 min. The laminates made under these conditions with polyamide PPA1 and PPA2 standard without additive were of poor quality and could not be tested for mechanical properties.

It can be seen from the results in Table 3 that for laminates made with HTN's, void volume is reduced and flexural properties are significantly improved by the addition of diamines, with or without other additives.

1. A thermoplastic composite comprising a fibrous material selected from the group consisting of non-woven structures, textiles, fibrous battings and combinations thereof, said fibrous material being impregnated with a matrix resin composition, wherein the matrix resin composition is selected from polyamide compositions comprising an aliphatic polyamide, a semi-aromatic polyamide, and blends of the foregoing, and from 0.1 to 3.0 wt % of one or more diamines, based on the matrix resin composition.

2. The thermoplastic composite of claim 1, wherein the fibrous material is selected from (a) non-woven structures that have random fiber orientation with chopped or continuous fiber in the form of a mat, a needled mat or a felt; (b) non-woven structures that have aligned fiber orientation, in the form of unidirectional fiber strands; (c) multi-axial textiles; and combinations thereof.

3. The thermoplastic composite of claim 1, wherein the fibrous material comprises or consists of carbon fiber.

4. The thermoplastic composite of claim 1, wherein the matrix resin composition is selected from aliphatic polyamides, and blends thereof.

5. The thermoplastic composite of claim 1, wherein the matrix resin composition is selected from semi-aromatic polyamides and blends thereof.

6. The thermoplastic composite of claim 1, wherein the matrix resin composition is selected from blends of one or more aliphatic polyamides with one or more semi-aromatic polyamides.

7. The thermoplastic composite of claim 1, wherein the matrix resin composition is selected from the group consisting of:
(1) an aliphatic polyamide selected from poly(ε-caprolactam) (PA 6), poly(hexamethylene hexanediamide) (PA 66), poly(1,3-trimethylene hexanediamide) (PA3,6), poly(tetramethylene hexanediamide (PA46), poly(pentamethylene hexanediamide (PA56), hexamethylene dodecanediamide (PA612), poly(pentamethylene decanediamide) (PA510), poly(pentamethylene dodecanediamide) (PA512), poly(hexamethylene decanediamide) (PA610), poly(ε-caprolactam/hexamethylene hexanediamide) (PA6/66), poly(ε-caprolactam/hexamethylene decanediamide) (PA6/610), poly(ε-caprolactam/hexamethylene dodecanediamide) (PA6/612), poly(hexamethylene tridecanediamide) (PA613), poly(hexamethylene pentadecanediamide) (PA615), poly(ε-caprolactam/hexamethylene hexanediamide/hexamethylene decanediamide) (PA6/66/610), poly(ε-caprolactam/hexamethylene hexanediamide/hexamethylene dodecanediamide) (PA6/66/612), poly(ε-caprolactam/hexamethylene hexanediamide/hexamethylene decanediamide/hexamethylene dodecanediamide) (PA6/66/610/612), poly(2-methylpentamethylene hexanediamide/hexamethylene hexanediamide/) (PA D6/66), poly(decamethylene decanediamide) (PA1010), poly(decamethylene dodecanediamide) (PA1012), poly(11-aminoundecanamide) (PA11), poly(12-aminododecanamide) (PA12), PA6,12, PA12,12 and their copolymers and combinations;
(2) a polyamide synthesized from the moieties hexamethylene diamine (HMD), 2-methyl pentamethylene diamine (2-MPMD) and terephthalic acid;
(3) a polyamide synthesized from the moieties hexamethylene diamine (HMD), terephthalic acid and adipic acid, a polyamide synthesized from the moieties hexamethylene diamine (HMD), isophthalic acid and terephthalic acid; and
(4) blends of all of the foregoing polyamides.

8. The thermoplastic composite of claim 1, wherein the one or more diamines is selected from aromatic diamines and aliphatic diamines.

9. The thermoplastic composite of claim 1, wherein the one or more diamines is selected from C₃-C₁₂ aliphatic diamines.

10. The thermoplastic composite of claim 1, wherein the one or more diamines is selected from diamines of the Formula I: 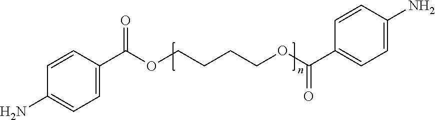
where n is an integer chosen from 1-10.

11. The thermoplastic composite of claim 1, wherein the one or more diamines is selected from hexamethylene diamine (HMD), 1,9-diaminononane (DAN), 1,8-diaminooctane (DAO), poly(1,4-butanediol)bis(4-aminobenzoate) (PBAB), and mixtures of these.

12. The thermoplastic composite of claim 1, wherein the one or more diamines is added at 0.5 to 1.5 wt % based on the matrix resin composition.

13. The thermoplastic composite of claim 1, wherein the matrix resin composition further comprises copper iodide, potassium iodide and aluminum stearate.

14. The thermoplastic composite of claim 12, wherein the copper iodide/potassium iodide/aluminum stearate is in a ratio Cul/KI/Al of 7/1/0.5.

15. The thermoplastic composite of claim 13, wherein the total of copper iodide, potassium iodide and aluminum stearate represents from 0.25 to 1.5 wt % based on the matrix resin composition.

16. The thermoplastic composite of claim 1, wherein the total of copper iodide, potassium iodide and aluminum stearate represents from 0.5 to 1.0 wt % based on the matrix resin composition.
